(19) United States
(12) Patent Application Publication
(10) Pub. No.: US 2025/0260290 A1
(43) Pub. Date: Aug. 14, 2025

(54) ELECTRIC COMPRESSOR

(71) Applicant: KABUSHIKI KAISHA TOYOTA JIDOSHOKKI, Kariya-shi (JP)

(72) Inventors: Yusuke IWASE, Kariya-shi (JP); Yusuke KINOSHITA, Kariya-shi (JP); Koki SHINOHARA, Kariya-shi (JP)

(73) Assignee: KABUSHIKI KAISHA TOYOTA JIDOSHOKKI, Kariya-shi (JP)

(21) Appl. No.: 19/022,043

(22) Filed: Jan. 15, 2025

(30) Foreign Application Priority Data
Feb. 8, 2024 (JP) 2024-017770

(51) Int. Cl. H02K 5/22; F04C 18/02; H02K 11/33

(52) U.S. Cl. CPC H02K 5/225; F04C 18/0215; H02K 11/33; F04C 2240/403; H02K 2211/03

(57) ABSTRACT

An electric compressor includes a compression part, a motor, and an inverter. The inverter has a circuit board and a connector mounted on the circuit board, the connector having a case in which a connecting terminal that is electrically connected to a circuit pattern formed on the circuit board is accommodated. The circuit board has a through hole. The case has a protruding portion that is inserted into the through hole and in which an insertion port is opened, the insertion port guiding a lead that is electrically connected to the connecting terminal toward the connecting terminal. A hole from which the lead is exposed is formed on a side of the case opposite to the insertion port across the connecting terminal.

### CROSS-REFERENCE OF THE RELATED APPLICATION

This application claims priority to Japanese Patent Application No. 2024-017770 filed on Feb. 8, 2024, the entire disclosure of which is incorporated herein by reference.

### BACKGROUND ART

The present disclosure relates to an electric compressor.

The electric compressor includes a compression part and a motor. The compression part compresses a fluid. The motor drives the compression part. In addition, for example, as in Japanese Patent Application Publication No. 2019-203448, the electric compressor includes an inverter. The inverter drives the motor. The inverter has a circuit board. In addition, as in Japanese Patent Application Publication No. 2022-137909, the inverter has a connector that is mounted on the circuit board. The connector has a case in which connecting terminals are accommodated. Insertion ports into which leads are inserted are opened in the case. The connecting terminals electrically connect the leads to a circuit pattern formed on the circuit board.

In such electric compressors, the circuit board may be provided between the leads and the connector in a direction into which the leads are inserted. In this case, it is necessary to form a through hole in the circuit board and to insert the leads into the insertion ports as well as into the through hole of the circuit board. Here, when the leads are inserted into the insertion ports of the connector, for example, each of the leads may be accidentally inserted into a gap between the through hole of the circuit board and the case of the connector instead of being inserted into the insertion ports of the connector. Accordingly, an electric compressor in which a worker can easily confirm that the leads are connected to the connecting terminals has been desired.

### SUMMARY

In accordance with an aspect of the present disclosure, there is provided an electric compressor that includes a compression part configured to compress a fluid, a motor configured to drive the compression part, and an inverter configured to drive the motor. The inverter has a circuit board and a connector mounted on the circuit board, the connector having a case in which a connecting terminal that is electrically connected to a circuit pattern formed on the circuit board is accommodated. The circuit board has a through hole. The case has a protruding portion that is inserted into the through hole and in which an insertion port is opened, the insertion port guiding a lead that is electrically connected to the connecting terminal toward the connecting terminal. A hole from which the lead is exposed is formed on a side of the case opposite to the insertion port across the connecting terminal.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of an electric compressor according to an embodiment;

FIG. 2 is an enlarged cross-sectional view illustrating a part of the electric compressor;

FIG. 3 is a cross-sectional view illustrating a relationship between a protruding portion and a through hole;

FIG. 4 is a perspective view illustrating a state in which leads are inserted in insertion ports; and

FIG. 5 is a perspective view illustrating a state in which the leads extend out through holes.

### DETAILED DESCRIPTION OF THE EMBODIMENTS

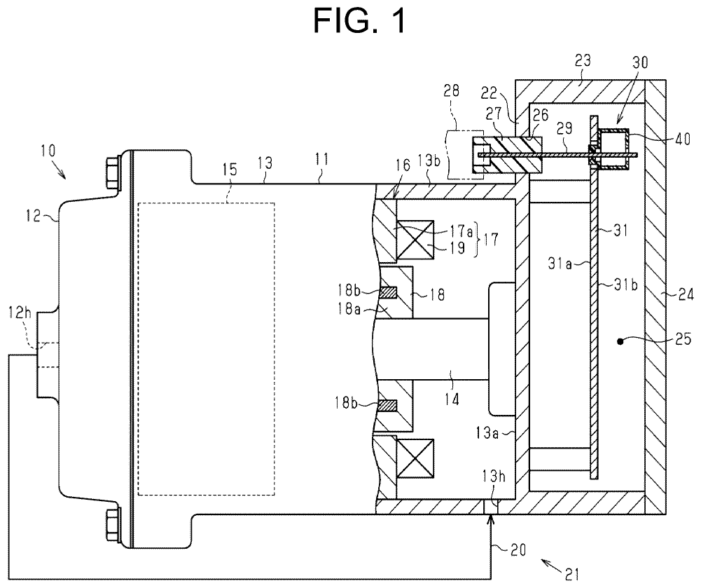

The following will describe an embodiment of an electric compressor according to the present disclosure with reference to FIGS. 1 to 5. The electric compressor of the present embodiment is used, for example, in a vehicle air conditioner.

### <Overview of Electric Compressor>

As illustrated in FIG. 1, the electric compressor 10 includes a housing 11. The housing 11 has a discharge housing 12 and a motor housing 13. The discharge housing 12 and the motor housing 13 are each formed in a tubular shape. The motor housing 13 is connected to the discharge housing 12. The discharge housing 12 and the motor housing 13 are made of metal material. The discharge housing 12 and the motor housing 13 are made of aluminum, for example. The motor housing 13 has an end wall 13a formed in a plate shape and a peripheral wall 13b formed in a tubular shape. The peripheral wall 13b extends from an outer peripheral portion of the end wall 13a.

The electric compressor 10 includes a rotary shaft 14. The rotary shaft 14 is accommodated in the motor housing 13. That is, the rotary shaft 14 is accommodated in the housing 11. The rotary shaft 14 is rotatably supported by the motor housing 13.

The electric compressor 10 includes a compression part 15 and a motor 16. The compression part 15 and the motor 16 are accommodated in the motor housing 13. That is, the compression part 15 and the motor 16 are accommodated in the housing 11. The compression part 15 and the motor 16 are arranged in an axial direction of the rotary shaft 14, which is a direction in which a rotating axis of the rotary shaft 14 extends. The motor 16 is located closer to the end wall 13a of the motor housing 13 than the compression part 15.

The compression part 15 is driven by the rotation of the rotary shaft 14. The compression part 15 compresses a refrigerant as a fluid. The compression part 15 is, for example, a scroll type compression part having a fixed scroll that is fixed to the motor housing 13 therein and an orbiting scroll that is disposed so as to face the fixed scroll. Note that illustrations of the fixed scroll and the orbiting scroll are omitted.

The motor 16 has a stator 17 formed in a tubular shape and a rotor 18 formed in a tubular shape. The rotor 18 is disposed inside the stator 17. The rotor 18 is formed so as to be rotatable integrally with the rotary shaft 14. The rotor 18 has a rotor core 18a and a plurality of permanent magnets 18b. The rotor core 18a is fixed to the rotary shaft 14. The plurality of permanent magnets 18b are provided in the rotor core 18a. The stator 17 surrounds the rotor 18. The stator 17 has a stator core 17a formed in a tubular shape and a motor coil 19. The motor coil 19 is formed by being wound around the stator core 17a. A power is supplied to the motor coil 19 to rotate the rotor 18 and the rotary shaft 14 rotates integrally with the rotor 18. The compression part 15 is driven with the rotation of the rotary shaft 14. Thus, the motor 16 drives the compression part 15.

The housing 11 has a suction port 13h. The suction port 13h is formed at a portion of the peripheral wall 13b near the end wall 13a in the motor housing 13. The refrigerant is sucked into the motor housing 13 through the suction port 13h. A first end of an external refrigerant circuit 20 is connected to the suction port 13h. The housing 11 has a discharge port 12h. The discharge port 12h is formed in the discharge housing 12. A second end of the external refrigerant circuit 20 is connected to the discharge port 12h.

The refrigerant sucked into the motor housing 13 from the first end of the external refrigerant circuit 20 through the suction port 13h is compressed by the driving of the compression part 15. The refrigerant compressed by the compression part 15 flows into the second end of the external refrigerant circuit 20 through the discharge port 12h. Then, the refrigerant that has flowed into the external refrigerant circuit 20 flows to a heat exchanger and an expansion valve of the external refrigerant circuit 20, and then, returns into the motor housing 13 through the suction port 13h. The electric compressor 10 and the external refrigerant circuit 20 are a part of a vehicle air conditioner 21.

The motor housing 13 has a protruding wall 22 and an extending wall 23. The protruding wall 22 protrudes outward in a radial direction of the peripheral wall 13b from a portion of an outer peripheral surface of the peripheral wall 13b in the motor housing 13. The protruding wall 22 is continuous with the end wall 13a of the motor housing 13 in the radial direction of the peripheral wall 13b of the motor housing 13. A thickness direction of the protruding wall 22 coincides with a thickness direction of the end wall 13a of the motor housing 13. The extending wall 23 is formed in a tubular shape extending from the outer peripheral portion of the protruding wall 22 and the outer peripheral portion of the end wall 13a of the motor housing 13 away from the peripheral wall 13b.

The electric compressor 10 includes a cover 24. The cover 24 is a part of the housing 11. That is, the housing 11 has the cover 24. The cover 24 is formed in a plate shape. The cover 24 is connected to the extending wall 23 while covering an opening of the extending wall 23. An inverter chamber 25 is defined by the end wall 13a of the motor housing 13, the protruding wall 22, the extending wall 23, and the cover 24. Thus, the inverter chamber 25 is defined by the housing 11.

The protruding wall 22 has an attachment hole 26. The attachment hole 26 extends through the protruding wall 22 in the thickness direction thereof. The attachment hole 26 is, at a first end thereof, opened in a surface of the protruding wall 22, which is located far from the extending wall 23. The attachment hole 26 is, at a second end thereof, opened to the inverter chamber 25.

The electric compressor 10 includes a connector connecting portion 27. The connector connecting portion 27 is formed in a tubular shape. The connector connecting portion 27 is made of resin. The connector connecting portion 27 is attached to the attachment hole 26. A first end of the connector connecting portion 27 extends out through the attachment hole 26 to an outside of the housing 11. A second end of the connector connecting portion 27 extends out through the attachment hole 26 into the inverter chamber 25. The connector connecting portion 27 is of a female type, and an external connector 28 of a male type is connectable to the first end of the connector connecting portion 27. The external connector 28 is electrically connected to a vehicle side low voltage battery, which is not illustrated. In addition, the external connector 28 is also electrically connected to a vehicle ECU as an upper-level ECU, which is not illustrated.

The electric compressor 10 includes leads 29. The leads 29 are held by the connector connecting portion 27. That is, the connector connecting portion 27 holds three leads 29. The leads 29 are each formed in a rectangular plate shape. The leads 29 are held by the connector connecting portion 27 in a state where the leads 29 are arranged in a line. The leads 29 extend through the connector connecting portion 27. A first end of each of the leads 29 is located inside the connector connecting portion 27 at the first end thereof. A second end of each of the leads 29 extends out through the second end of the connector connecting portion 27 into the inverter chamber 25. When the external connector 28 is connected to the first end of the connector connecting portion 27, the external connector 28 and the leads 29 are electrically connected to each other.

The electric compressor 10 includes an inverter 30. The inverter 30 is accommodated in the inverter chamber 25. That is, the inverter chamber 25 accommodates the inverter 30. The inverter 30 drives the motor 16. The compression part 15, the motor 16, and the inverter 30 are arranged in this order in the axial direction of the rotary shaft 14.

The inverter 30 has, for example, a switching element that performs switching operation in order to drive the motor 16, a filter element that reduces noise, and the like. In addition, the inverter 30 has, for example, a control circuit that controls the switching operation of the switching element.

### <Circuit Board>

The inverter 30 has a circuit board 31. The circuit board 31 is disposed in the inverter chamber 25 with a thickness direction of the circuit board 31 coinciding with the thickness direction of the end wall 13a of the motor housing 13 and the thickness direction of the protruding wall 22. A part of the circuit board 31 is overlapped with the connector connecting portion 27 in the thickness direction of the circuit board 31. The circuit board 31 has a first surface 31a and a second surface 31b. The first surface 31a is a surface of the circuit board 31 that is located near the connector connecting portion 27. The second surface 31b is a surface that is located opposite to the first surface 31a. The second surface 31b faces the cover 24 in the thickness direction of the circuit board 31.

### <Circuit Pattern>

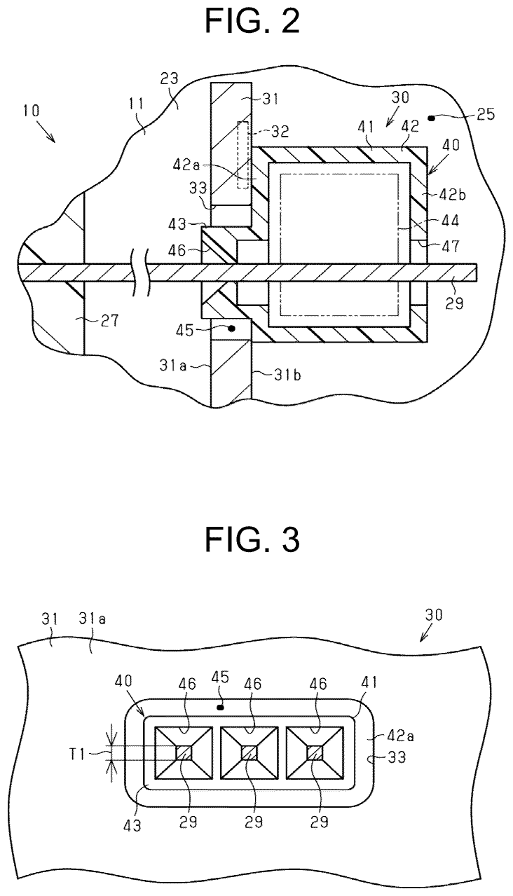

As illustrated in FIG. 2, the circuit board 31 has a circuit pattern 32. The circuit pattern 32 is formed on the circuit board 31.

### <Through Hole>

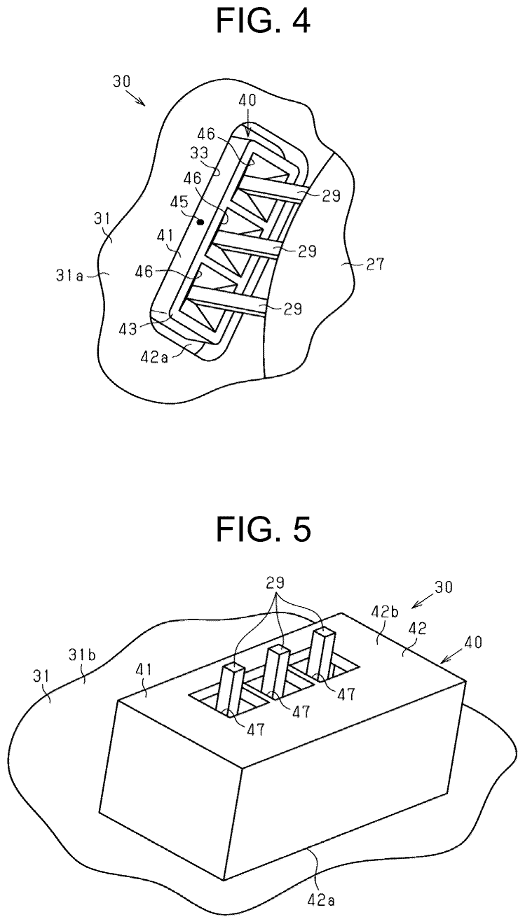

As illustrated in FIGS. 2 to 4, the circuit board 31 has a through hole 33. As illustrated in FIG. 2, the through hole 33 is formed at a position in the circuit board 31 at which the through hole 33 is overlapped with the connector connecting portion 27 in the thickness direction of the circuit board 31. The through hole 33 is, at a first end thereof, opened in the first surface 31a of the circuit board 31. The through hole 33 is, at a second end thereof, opened in the second surface 31b of the circuit board 31. As illustrated in FIGS. 3 and 4, the through hole 33 has an elongated circular shape. A longitudinal direction of the through hole 33 coincides with a direction in which the three leads 29 are arranged.

### <Connector>

As illustrated in FIGS. 2 to 4, the inverter 30 has a connector 40. The connector 40 is made of resin. The connector 40 is mounted on the circuit board 31. The connector 40 has a case 41. The case 41 has a case main body 42 and a protruding portion 43. The case main body 42 is formed in a rectangular box shape.

As illustrated in FIG. 2, connecting terminals 44 are accommodated in the case main body 42. That is, the connecting terminals 44 are accommodated in the case 41. Note that although the three connecting terminals 44 corresponding to the leads 29 are accommodated in the case main body 42, one of the three connecting terminals 44 is illustrated in FIG. 2 for the sake of illustration. The connecting terminals 44 are electrically connected to the circuit pattern 32.

The case main body 42 has a first wall 42a and a second wall 42b. The first wall 42a and the second wall 42b face each other. The first wall 42a faces the second surface 31b of the circuit board 31. The second wall 42b is located opposite to the first wall 42a across the connecting terminals 44. The case 41 is disposed on the circuit board 31 that is interposed between the case 41 and the connector connecting portion 27.

The protruding portion 43 protrudes from the first wall 42a. As illustrated in FIGS. 3 and 4, the protruding portion 43 is formed in a rectangular tubular shape. The protruding portion 43 is inserted in the through hole 33. Specifically, the protruding portion 43 is inserted into the through hole 33 from a side opposite to the connector connecting portion 27 across the circuit board 31. When the protruding portion 43 and the through hole 33 are viewed in a plan view, a longitudinal direction of the protruding portion 43 coincides with the longitudinal direction of the through hole 33. A portion of the first wall 42a closes a gap 45 between the protruding portion 43 and the through hole 33.

Three insertion ports 46 are opened in the protruding portion 43. The insertion ports 46 are each formed in a quadrilateral shape. As illustrated in FIG. 2, each of the insertion ports 46 is, at a first end thereof, opened in a surface of the protruding portion 43, which is located far from the first wall 42a. Each of the insertion ports 46, at a second end thereof, communicates with an inside of the case main body 42. As illustrated in FIGS. 3 and 4, the three insertion ports 46 are arranged in the longitudinal direction of the protruding portion 43. In each of the insertion ports 46, inner surfaces defining the insertion port 46 are formed so as to be tapered surfaces such that an opening area of the insertion port 46 is gradually decreased as the inner surfaces extend from the surface of the protruding portion 43, which is located far from the first wall 42a. Then, each of the insertion ports 46 guides the corresponding lead 29, which is electrically connected to the corresponding connecting terminal 44, toward the connecting terminal 44. Thus, the insertion ports 46 are opened in the protruding portion 43 and the insertion ports 46 guide the leads 29, which are electrically connected to the connecting terminals 44, toward the connecting terminals 44.

### <Relationship Between Lead and Gap>

As illustrated in FIG. 3, a dimension of the gap 45 between the protruding portion 43 and the through hole 33 is greater than a thickness T1 of a portion of each of the leads 29, which is inserted into the corresponding insertion port 46. Note that a cross-sectional shape of the portion of each of the leads 29, which is inserted into the insertion port 46, is square. Here, the connector 40 is mounted on the circuit board 31 with some play, so that the dimension of the gap 45 between the protruding portion 43 and the through hole 33 changes according to a movement of the protruding portion 43 relative to the through hole 33. At this time, even when the protruding portion 43 moves relative to the through hole 33, there is always a portion of the gap 45 between the protruding portion 43 and the through hole 33 at which the dimension therebetween is greater than the thickness T1 of each of the leads 29 around the entire circumference of the protruding portion 43. Thus, the dimension of the gap 45 between the protruding portion 43 and the through hole 33 is greater than the thickness T1 of each of the leads 29.

### <Hole>

As illustrated in FIG. 5, three holes 47 for exposure are formed in the second wall 42b of the case main body 42. The holes 47 extend through the second wall 42b of the case main body 42 in a thickness direction of the second wall 42b. The three holes 47 are arranged in a longitudinal direction of the case main body 42. The holes 47 are each formed in a quadrilateral shape. As illustrated in FIG. 2, each of the holes 47 is, at a first end thereof, opened to an inside of the case main body 42. Each of the holes 47 is, at a second end thereof, opened to an outside of the case main body 42. Each of the holes 47 is located at a position at which the hole 47 is overlapped with the corresponding insertion port 46 in the thickness direction of the circuit board 31. With this configuration, the holes 47 are located opposite to the insertion ports 46 across the connecting terminals 44.

As illustrated in FIGS. 2 and 5, the second end of each of the leads 29 connected to the corresponding connecting terminal 44 extends out through the case main body 42 and the corresponding hole 47 to the outside of the case main body 42. Accordingly, the leads 29 extend out through the holes 47. With this configuration, the holes 47 through which the leads 29 are exposed are formed on a side of the case 41 opposite to the insertion ports 46 across the connecting terminals 44.

### Operation of Embodiment

The following will describe an operation of the present embodiment.

When the external connector 28 is connected to the connector connecting portion 27, a low voltage power from the vehicle side low voltage battery is supplied to the circuit pattern 32 of the circuit board 31 through the external connector 28, the leads 29, and the connecting terminals 44. This drives the inverter 30. In addition, when the external connector 28 is connected to the connector connecting portion 27, control signals from the vehicle ECU are input to the circuit pattern 32 of the circuit board 31 through the external connector 28, the leads 29, and the connecting terminals 44.

Then, the inverter 30 controls the switching operation of the switching element based on the control signals from the vehicle ECU. As a result, the inverter 30 is driven based on the control signals from the vehicle ECU. The inverter 30 converts a DC power from a vehicle side high voltage battery, which is not illustrated, to an AC power by the switching operation of the switching element. Then, the AC power is supplied to the motor 16 to drive the motor 16. Thus, the inverter 30 converts the DC power to the AC power and supplies the AC power to the motor 16 to drive the motor 16.

In such an electric compressor 10, when each of the leads 29 is connected to the corresponding connecting terminal 44 in the case 41 through the corresponding insertion port 46, the lead 29 may be accidentally inserted into a gap between the through hole 33 and the case 41 of the connector 40 instead of being inserted into the insertion port 46. Specifically, when each of the leads 29 is connected to the corresponding connecting terminal 44 in the case 41 through the corresponding insertion port 46, the lead 29 may be accidentally inserted into the gap 45 between the protruding portion 43 and the through hole 33 instead of being inserted into the insertion port 46. At this time, a worker can find each of the leads 29 not to be connected to the corresponding connecting terminal 44 by checking that the lead 29 is not exposed from the holes 47. In particular, since the case 41 closes the gap 45 between the protruding portion 43 and the through hole 33, when each of the leads 29 is inserted into the gap 45 between the protruding portion 43 and the through hole 33 instead of being inserted into the corresponding insertion port 46, the lead 29 comes in contact with the case 41. Accordingly, the worker easily finds the accidental insertion of each of the leads 29.

On the contrary, when each of the leads 29 is connected to the corresponding connecting terminal 44, the lead 29 is exposed from the corresponding hole 47. Thus, the worker can easily confirm that each of the leads 29 is connected to the corresponding connecting terminal 44. In particular, each of the leads 29 extends out through the corresponding hole 47, so that the worker further easily confirm that the lead 29 is connected to the connecting terminal 44 as compared with a case where the lead 29 do not extend out through the hole 47.

### Advantageous Effects of Embodiment

The above-described embodiment provides advantageous effects as follows.

(1) The holes 47 from which the leads 29 are exposed are formed on the side of the case 41 opposite to the insertion ports 46 across the connecting terminals 44, so that when the leads 29 are connected to the connecting terminals 44, the leads 29 are exposed from the holes 47. Thus, the worker can easily confirm that the leads 29 are connected to the connecting terminals 44.

(2) The dimension of the gap 45 between the protruding portion 43 and the through hole 33 is greater than the thickness T1 of each of the leads 29. Thus, even when the electric compressor 10 has a configuration in which the leads 29 are likely to be accidentally inserted into the gap 45 between the protruding portion 43 and the through hole 33, when the leads 29 are connected to the connecting terminals 44, the leads 29 are exposed from the holes 47. Accordingly, even when the electric compressor 10 has the configuration in which the leads 29 are likely to be accidentally inserted into the gap 45 between the protruding portion 43 and the through hole 33, the worker can easily confirm that the leads 29 are connected to the connecting terminals 44.

(3) The case 41 closes the gap 45 between the protruding portion 43 and the through hole 33. With this configuration, even when each of the leads 29 is accidentally inserted into the gap 45 between the protruding portion 43 and the through hole 33 instead of being inserted into the corresponding insertion port 46, the lead 29 comes in contact with the case 41. Accordingly, the worker easily finds the accidental insertion of each of the leads 29.

(4) The leads 29 extend out through the holes 47. With this configuration, the worker can further easily confirm that the leads 29 are connected to the connecting terminals 44 as compared with the case where the leads 29 do not extend out through the holes 47. In particular, since the leads 29 extend out through the holes 47, the worker can confirm that the leads 29 are connected to the connecting terminal 44 when viewed in a direction orthogonal to the thickness direction of the circuit board 31. Accordingly, the worker can further easily confirm that the leads 29 are connected to the connecting terminals 44.

(5) In each of the insertion ports 46, the inner surfaces defining the insertion port 46 are formed so as to be the tapered surfaces such that the opening area of the insertion port 46 is gradually decreased as the inner surfaces extend from the surface of the protruding portion 43, which is located far from the first wall 42a. With this configuration, while each of the leads 29 is guided by the inner surfaces defining the insertion port 46, the lead 29 passes through the insertion port 46. Accordingly, each of the leads 29 is easily guided toward the corresponding connecting terminal 44 due to the corresponding insertion port 46. Thus, this configuration makes the work of connecting the lead 29 to the corresponding connecting terminals 44 easier.

### Modification

The above-described embodiment may be modified as follows. The above-described embodiment and the following modifications may be combined with each other as long as they do not contradict each other.

In the embodiment, the dimension of the gap 45 between the protruding portion 43 and the through hole 33 may be equal to or less than the thickness T1 of each of the leads 29. For example, assume a case where the dimension of the gap 45 between the protruding portion 43 and the through hole 33 is less than the thickness T1 of each of the leads 29. Even in this case, when the leads 29 are connected to the connecting terminals 44 in the case 41 through the insertion ports 46, each of the leads 29 may be inserted into the gap 45 between the protruding portion 43 and the through hole 33. At this time, the worker can find each of the leads 29 not to be connected to the corresponding connecting terminal 44 by checking that the lead 29 is not exposed from the hole 47. In addition, when the leads 29 are connected to the connecting terminals 44, the leads 29 are exposed from the holes 47. Thus, the worker can easily confirm that the leads 29 are connected to the connecting terminals 44.

In the embodiment, the case 41 need not close the gap 45 between the protruding portion 43 and the through hole 33.

In the embodiment, the leads 29 need not extend out through the holes 47. Even in this case, the worker determines whether each of the leads 29 is exposed from the corresponding hole 47 when viewed in the thickness direction of the circuit board 31. Then, when the leads 29 are exposed from the hole 47, the worker determines that the leads 29 are connected to the connecting terminals 44. Thus, the worker can easily confirm that the leads 29 are connected to the connecting terminals 44.

In the embodiment, the inner surfaces defining each of the insertion ports 46 need not be formed so as to be the tapered surfaces such that the opening area of the insertion port 46 is gradually decreased as the inner surfaces extend from the surface of the protruding portion 43, which is located far from the first wall 42a.

In the embodiment, a shape of the through hole 33 is not particularly limited. A shape of the protruding portion 43 may be changed as appropriate depending on the shape of the through hole 33.

In the embodiment, the cross-sectional shape of the portion of each of the leads 29, which is inserted into the corresponding insertion port 46, is not limited to the square. For example, it may be circular or rectangular, for example. A shape of each of the insertion ports 46 may be changed as appropriate depending on the cross-sectional shape of the portion of the lead 29, which is inserted into the insertion port 46.

In the embodiment, the number of the leads 29 is not particularly limited. Note that the number of the insertion ports 46 and the number of the holes 47 are changed as appropriate depending on the number of the leads 29.

In the embodiment, the external connector 28 that is connected to the connector connecting portion 27 may be a connector through which a high voltage DC power from the vehicle side high voltage battery is supplied to the inverter 30.

In the embodiment, for example, the inverter chamber 25 may be defined by a tubular case main body that is separately provided from the motor housing 13 and attached to the end wall 13a of the motor housing 13 and a cover member that covers an opening of the case main body.

In the embodiment, the electric compressor 10 may have a configuration in which for example, the inverter 30 is disposed outside the housing 11 in a radial direction of the rotary shaft 14. In short, the compression part 15, the motor 16, and the inverter 30 need not be arranged in this order in the axial direction of the rotary shaft 14.

In the embodiment, the compression part 15 is not limited to a scroll type compression part and may be a piston type compression part, a vane type compression part, a rotary type compression part, or the like, for example.

In the embodiment, the electric compressor 10 is a part of the vehicle air conditioner 21; however, the present disclosure is not limited thereto. For example, the electric compressor 10 may be mounted on a fuel cell vehicle and the compression part 15 of such an electric compressor 10 may compress air as a fluid that is supplied to fuel cells.

### Supplementary Notes

The following will describe technical ideas that can be obtained from the above-described embodiment and the modifications.

### <Supplementary Note 1>

An electric compressor including:
a compression part configured to compress a fluid;
a motor configured to drive the compression part; and
an inverter configured to drive the motor,
the inverter having:
   a circuit board; and
   a connector mounted on the circuit board, the connector having a case in which a connecting terminal that is electrically connected to a circuit pattern formed on the circuit board is accommodated,
the circuit board having a through hole, and
the case having a protruding portion that is inserted into the through hole and in which an insertion port is opened, the insertion port guiding a lead that is electrically connected to the connecting terminal toward the connecting terminal, characterized in that
a hole from which the lead is exposed is formed on a side of the case opposite to the insertion port across the connecting terminal.

### <Supplementary Note 2>

The electric compressor according to supplementary note 1, characterized in that a dimension of a gap between the protruding portion and the through hole is greater than a thickness of the lead.

### <Supplementary Note 3>

The electric compressor according to supplementary note 1 or 2, characterized in that the case closes the gap between the protruding portion and the through hole.

### <Supplementary Note 4>

The electric compressor according to any one of supplementary notes 1 to 3, characterized in that the lead extends out through the hole.

What is claimed is:

1. An electric compressor comprising:
a compression part configured to compress a fluid;
a motor configured to drive the compression part; and
an inverter configured to drive the motor,
the inverter having:
a circuit board; and
a connector mounted on the circuit board, the connector having a case in which a connecting terminal that is electrically connected to a circuit pattern formed on the circuit board is accommodated,
the circuit board having a through hole, and
the case having a protruding portion that is inserted into the through hole and in which an insertion port is opened, the insertion port guiding a lead that is electrically connected to the connecting terminal toward the connecting terminal, wherein
a hole from which the lead is exposed is formed on a side of the case opposite to the insertion port across the connecting terminal.

2. The electric compressor according to claim 1, wherein
a dimension of a gap between the protruding portion and the through hole is greater than a thickness of the lead.

3. The electric compressor according to claim 1, wherein
the case closes the gap between the protruding portion and the through hole.

4. The electric compressor according to claim 1, wherein
the lead extends out through the hole.
